(19) United States
(12) Patent Application Publication
(10) Pub. No.: US 2003/0095795 A1
(43) Pub. Date: May 22, 2003

(54) PTC heating element

(76) Inventors: Walter G. Birdsell, Marlborough, MA (US); Bruce Chute, Northboro, MA (US)

Correspondence Address: DARBY & DARBY P.C., P. O. BOX 5257, NEW YORK, NY, 10150-5257, US

(21) Appl. No.: 09/991,161

(22) Filed: Nov. 21, 2001

(51) Int. Cl. H05B 3/00; F24H 3/00

(52) U.S. Cl. 392/365; 219/505; 219/540

(57) ABSTRACT

At least one aspect of the present invention relates to a system for heating a gas using positive temperature coefficient (PTC) elements. More particularly, aspects of the present invention are directed towards PTC element configurations and orientations. In one aspect of the present invention, PTC elements are interposed between heat sinks such that they transmit current from one heat sink to another. The PTC elements may be arranged in a radial configuration, which may have more than one PTC element per radial flange. The heat sinks may have grilles which allow air to flow perpendicular to the heat sinks and between the PTC elements.

### FIELD OF THE INVENTION

This invention relates to a heating apparatus. Specifically, this invention relates to heaters which incorporate a positive temperature coefficient (PTC) element.

### BACKGROUND OF THE INVENTION

Positive temperature coefficient (PTC) materials have been used in heating applications for many years. Upon application of an electric bias to a PTC material, it initially has a low electrical resistance and heats up quickly due to current flow through the material. However, once the PTC material reaches the Curie point, its resistance increases so that it maintains a substantially constant temperature and heat output. This self-regulating characteristic of PTC materials significantly decreases the potential for heating element burnout as well as the need for temperature-regulating electronics, and thus makes these materials attractive for use in heating elements such as those in space heaters, hair dryers, and other applications.

U.S. Pat. No. 4,654,510 to Umeya et al. describes one type of PTC heating element. Holes formed through the PTC element, parallel to the direction of current flow, provide a pathway for air. The air is heated as it passes through the PTC element.

U.S. Pat. No. 4,855,570 to Wang discloses another PTC element arrangement where the PTC elements are exposed directly to airflow. The heating unit described by Wang includes a plurality of PTC elements arranged radially between two cylindrical electrodes. The PTC elements are arranged so that their broad surfaces are parallel to air flow through the heating element.

Other heater designs include heat sinks which receive heat from the PTC elements and transfer it to air passing by and/or through the heat sinks. To increase the convective heat transfer to the air, these heat sinks typically have many holes providing paths for air flow. One such configuration is described in U.S. Pat. No. 4,654,510 to Nakamura et al., in which the heat sinks provide a plurality of fluid pathways for air to flow through. By orienting the fluid pathways in the heat sinks parallel to the broad surfaces of the PTC elements, these heating devices do not require holes through the PTC elements themselves. Additionally, Nakamura utilizes the heat sinks as electrodes which may stabilize current spikes and reduce the likelihood of PTC element burnout.

### SUMMARY OF THE INVENTION

In at least one aspect of the present invention, a heating element utilizing positive temperature coefficient (PTC) elements has sufficient surface area for effective heat transfer as well as the capability to heat a large volume of air without creating a large internal air resistance.

In another aspect of the present invention, an arrangement of PTC elements in a heating element can be configured to provide the desired heat output and desired heat distribution.

In another aspect of the present invention, a PTC heating element may be provided where broad surfaces of the PTC element(s) are arranged substantially perpendicular to the direction of airflow.

In another aspect of the present invention, a PTC heating element may include at least one heat sink and at least one PTC element, configured such that there is sufficient pressure between the PTC element and the heat sink to promote heat transfer and provide sufficient electrical and/or thermal contact between the PTC element and heat sink.

In another aspect of the present invention, a heating element includes a first heat sink and at least one PTC element thermally coupled to the first heat sink, aligned such that a current direction of the PTC element (i.e., the direction in which current would flow if an electric bias were applied to the heating element) is substantially parallel to a fluid pathway formed by openings in the first heat sink.

In another aspect of the present invention, a heating element includes a first heat sink and a PTC element thermally coupled to the first heat sink positioned substantially out of a fluid pathway formed by openings in the first heat sink so that a largest surface area of the PTC element is approximately perpendicular to the fluid pathway.

In another aspect of the present invention, a heating element includes at least one heat sink and a PTC element thermally coupled to the heat sink such that at least 50% of the heat output by the PTC element is transferred to heat sink(s) coupled to the PTC element and arranged so that a largest surface of the PTC element is approximately perpendicular to a fluid pathway formed by opening(s) in the heat sink(s).

In another aspect of the present invention, a heating element includes first and second heat sinks with openings that form a fluid pathway and a plurality of PTC elements substantially aligned in a single plane such that the current direction of the PTC elements is substantially parallel to one another and the PTC elements are arranged radially inside a circle, where the first and second heat sinks are configured to act as electrodes for the plurality of PTC elements.

In another aspect of the present invention, a heating element includes a heat sink and at least one PTC element in thermal communication with the heat sink, where a fluid pathway formed by at least one opening in the heat sink first passes either the heat sink or the PTC element and then passes the other.

In another aspect of the present invention, a heater includes an air circulator to move air through a heating element, where the heating element includes a first heat sink thermally coupled to at least one PTC element, where the PTC element is aligned such that the current direction is substantially parallel to a fluid pathway formed by the first heat sink.

In another aspect of the present invention, a heating element has a plurality of PTC elements radially arranged within a circle. The radial arrangement includes radial flanges, and at least one radial flange may include one or more PTC elements. In one embodiment, the heat sinks may shield the PTC elements from direct air flow. The heat sinks may also act as electrodes to the PTC elements. If the heat sinks function as electrodes, electrically non-conductive fasteners connecting the heat sinks and PTC elements may be used so as to avoid short circuiting the heat sinks when an electric bias is applied. The fasteners may additionally apply pressure between the plurality of PTC elements and heat sinks.

These and other features of the present invention will be elucidated through the accompanying drawings and detailed description below.

### BRIEF DESCRIPTION OF THE DRAWINGS

FIG. 1 is a perspective exploded view of one embodiment of a heating element in one aspect of the present invention;

FIG. 2 is a side view of one embodiment of a heating element in one aspect of the present invention;

FIGS. 3 through 11 are top views of different PTC element arrangements according to one aspect of the present invention; and

FIG. 12 is a side view of a heater utilizing a PTC heating element in one aspect of the present invention.

### DETAILED DESCRIPTION

A heating element according to aspects of the present invention can be sized and configured for any suitable use. For example, a heating element according to aspects of the invention may be used to heat air in an electric portable space heater, hair dryer, heat gun, etc. Although embodiments are described below in connection with heating air, a heating element in accordance with at least one aspect of the invention may be used to heat any suitable material, whether a gas, liquid or solid. As used herein, the term fluid refers to both gases and liquids.

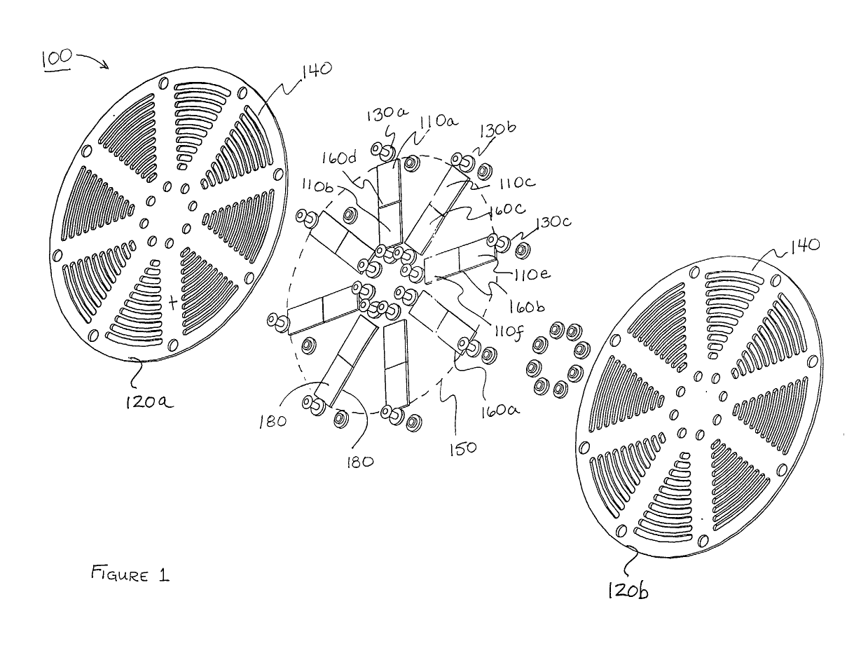

FIG. 1 shows an illustrative embodiment of a heating element 100 that incorporates various aspects of the invention. In this embodiment, the heating element 100 includes a plurality of PTC elements 110 disposed between a pair of heat sinks 120, although any number of PTC elements 110 and heat sinks 120, such as one each, may be used. The heat sinks 120 are electrically and thermally coupled to the PTC elements 110 so that electric current and heat may be conducted between them. In this embodiment, the heat sinks 120 have solid portions which electrically and/or thermally contact the PTC elements 110, as well as openings 140 between the solid portions which enable fluid flow (e.g., air flow) through the heat sinks 120. Thus, when an electric bias is applied to the heat sinks 120 and/or other electrodes, the resulting current through the PTC elements 110 causes the PTC elements 110 and heat sinks 120 to heat up. In turn, the heat sinks 120 may transfer at least a portion of the heat to air passing through the openings 140 and/or around the heat sinks 120.

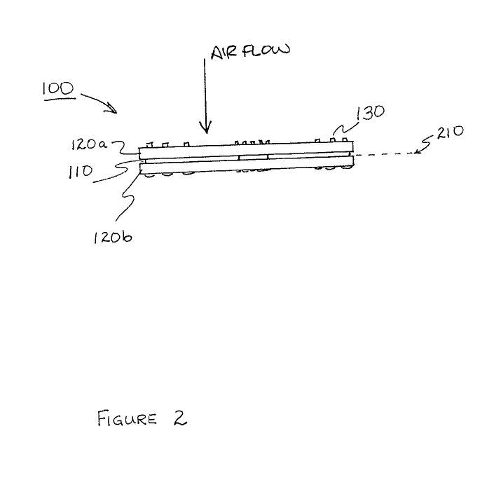

In accordance with one aspect of the invention, the openings 140 may form a fluid pathway through a heat sink 120 that is substantially perpendicular to a plane in which at least some of the PTC elements 110 are arranged. For example, air may pass through the heating element 100 in a direction approximately perpendicular to the first heat sink 120a and a plane of PTC elements 110 (e.g., the plane 210 shown in FIG. 2). As a result, the air may flow sequentially past the heat sinks 120 and PTC elements 110, e.g., first past the first heat sink 120a, then past a plane in which at least some of the PTC elements 110 are arranged, and then past the second heat sink 120b. In the embodiment of FIG. 1, the two heat sinks 120 act as both heat conductors and electrodes for the PTC elements 110, although such dual operation is not necessary. If a single heat sink 120 is used, the PTC elements 110 and heat sink 120 may be arranged in any suitable arrangement relative to air flow through the heating element 100, e.g., either the first or second heat sinks 120a or 120b may be eliminated. When a single heat sink is used, a complete electric circuit may be constructed by connecting an electrode to the PTC elements 110 on the side opposite the single heat sink 120.

In another aspect of the invention, PTC elements 110 may be arranged so that a current direction of the PTC elements 110, or direction that the current would flow when an electric bias is applied, is substantially parallel to a fluid pathway through a heating element 100, or a portion of the heating element 100. For example, although the PTC elements 110 may take any suitable shape, size or other feature, in the FIG. 1 embodiment, the PTC elements 110 each have a pair of opposing, broad-surfaces 180 with a relatively large surface area that are configured to transmit current to and from the heat sinks 120 when an electric bias is applied. In this embodiment, current will flow from one heat sink 120 to another through the PTC elements 110 in a direction approximately parallel to an air path through the heating element 100.

In another aspect of the invention, the broad surfaces 180, which may be the surfaces with the largest surface area of the PTC element 110, may be approximately perpendicular to the fluid pathway. For example, the broad opposing surfaces 180 may be aligned such that at least some of the PTC elements 110 are arranged in one or more planes, such as the plane 210 shown in FIG. 2. In this embodiment, the fluid flow direction through the heating element 100 is approximately perpendicular to the surfaces 180 of the PTC elements 110. The approximately perpendicular direction of fluid flow through the heating element 100 need not require that all individual flow paths in an overall fluid flow or all molecules in a fluid flow follow a perpendicular path through the heating element, but rather that the overall direction of movement of air is approximately perpendicular to the heating element. For example, water flow in a river is said to generally be in a particular direction, i.e., the overall flow direction of the river, even though particular parts of the river may have currents, eddies and other flows that are not necessarily aligned with the overall flow of the river. A similar situation may exist in the fluid flow through the heating element, and thus fluid flow direction may refer either to particular localized flow or the overall flow of fluid through the element.

In another aspect of the invention, the PTC elements may be arranged in a radial arrangement in a way similar to spokes in a bicycle wheel. For example, as shown in FIG. 1, the PTC elements 110 may have a radial arrangement such that the PTC elements 110 are arranged within a circle 150. As seen in FIG. 1, the radial arrangement may include any suitable number of radial spokes, or flanges 160, and any number of PTC elements in any one of the flanges 160. A radial arrangement of PTC elements 110 within a circle 150 may provide an even heat distribution in the heating element 100, e.g., when a standard radial fan is used to move fluid through and/or around the heating element 100. Of course, the PTC elements 110 may be arranged in any suitable way, such as in a linear array, a concentric circular pattern, and so on.

In another aspect of the invention, since the heat sinks 120 may be thermally conductive, the PTC elements 110 may be thermally coupled to the heat sinks 120 such that they transfer at least a portion of the heat they generate to at least one heat sink 120. For example, the PTC elements 110 may transfer at least 50% of the heat they generate to one or more heat sinks 120. Preferably, the PTC elements 110 transfer at least 70% of the heat they generate to the heat sinks 120. More preferably, the PTC elements 110 transmit at least 80% of the heat they generate to the heat sinks 120. Because the heat from the PTC elements 110 may be transferred to the heat sinks 120 by conduction, the contact surface area between the heat sinks 120 and the PTC elements 110 may be relatively large. Although in the FIG. 1 embodiment the contact area between the heat sinks 120 and the PTC elements 110 is flat, the contact area may have any suitable surface features, such as corrugations, grooves, recesses, etc., to enhance thermal and/or electrical contact between the heat sinks 120 and the PTC elements 110.

In another aspect of the invention and as discussed above, the heat sinks 120 may act as electrodes for the PTC elements 110. When used as electrodes, the heat sinks 120 may stabilize current spikes and thus protect the PTC elements 110. Therefore, the heat sinks 120 may be in electrical contact with the PTC elements 110 and may include an electrically conductive material such as a metal. The heat sinks 120 may also include a thermally and electrically conductive material such as copper, stainless steel, or steel. In this embodiment, the heat sinks 120 are formed from a plate or sheet of metal, such as aluminum, and the openings are stamped, machined or otherwise produced in the sheet. However, aspects of the invention are not limited to heat sinks 120 that are formed as flat plates, but instead may have any suitable arrangement, whether for functioning as an electrode or a heat transfer mechanism. For example, the heat sinks 120 may have fins, corrugations, or other features to enhance heat transfer. In addition, the heat sinks 120 need not be made from a single material or as a single piece. Instead, the heat sinks 120 may be made in multiple parts and/or from two or more different materials. Furthermore, the heat sink materials may include insulators, conductors and/or semiconductors in any suitable arrangement. If desired, a conductive grease can also be used between the PTC elements 110 and the heat sinks 120 to improve the electrical and/or thermal contact between these elements. With the heating element 100 configured in this way, one of the heat sinks 120 can be positively electrically charged and the second can be electrically neutral as shown in FIG. 2.

The openings 140 in the heat sinks 120 may be sized and configured to provide both a large surface area for effective heat convection and heat and/or electrical conduction as well as large vents to promote relatively unhindered air flow through the heating element 100. As known by those of skill in the art, the configuration of openings 140 can be designed and configured for the specific fan blade size, volume of unheated fluid moving through the heating element 100, and amount of expansion of the fluid due to heating occurring within the heating element 100.

Although not necessary, the openings 140 in the heat sinks 120 may be aligned to create a substantially straight fluid pathway through the heating element 100 and thus reduce resistance to fluid flow. The fluid pathway created by the openings 140 may be substantially parallel to the current direction through the PTC elements 110 when an electric bias is applied and/or substantially perpendicular to the opposing broad sides of the PTC elements 110.

In one aspect of the invention, the heat sinks 120 may substantially shield the PTC elements 110 from the fluid pathway. For example, as shown in FIG. 1, if the PTC elements 110 are aligned under solid portions of the heat sinks 120, the heat sinks 120 may substantially shield the PTC elements 110 from direct fluid flow and furthermore may provide a larger conductive and convective heat transfer surface for the fluid and PTC elements 110. In one embodiment, the heat sinks 120 substantially shield the PTC elements 110 from the fluid pathway such that the fluid pathway may be adjacent to less than 50% of the PTC elements' 110 surface area. In other words, the fluid pathway does not contact the majority of the PTC elements' 110 surface area. The fluid pathway may preferably be adjacent to less than 30% of the PTC elements' 110 surface area. More preferably, the fluid pathway may be adjacent to less than 20% of the PTC elements' 110 surface area. However, it should be understood that the PTC elements 110 may be partially or wholly exposed to fluid flow by the openings 140 in the heat sinks 120, and the PTC elements 110 may include openings through which fluid flows as well.

As shown in FIGS. 1 and 2, the heating element 100 may include fasteners 130, such as rivets, bolts, screws, etc., which hold the PTC elements 110 firmly between the heat sinks 120. If one heat sink is used, fasteners 130 may be employed to hold the PTC elements 110 to the heat sink 120. Additionally, if the heat sinks 120 are used as electrodes, the fasteners 130 may be electrically non-conductive, e.g., at least partially composed of plastics, ceramics, and non-conductive metals. Using non-conductive materials for the fasteners 130 may prevent the heating unit 100 from electrically short circuiting when an electric bias is applied. However, other means, such as interposing an insulating material between the fasteners 130 and the heat sinks 120, are available to prevent short circuiting as known by those of skill in the art. Of course, the heating element 100 may be held together by other means, such as one or more clamps, adhesives, etc. or a combination of fasteners, clamps, adhesives, etc.

The fasteners 130 may be sized and configured to generate pressure between the PTC elements 110 and the heat sinks 120, thereby creating sufficient contact between the heat sinks 120 and the PTC elements 110. Sufficient pressure between the PTC elements 110 and heat sinks 120 may help secure the PTC elements 110 in place and/or may improve the electrical and/or thermal contact between the heat sinks 120 and the PTC elements 110, thereby potentially making the heating element 100 more efficient. The fasteners 130 may be placed around or through the PTC elements 110 such that they generate pressure directly on the PTC elements 110.

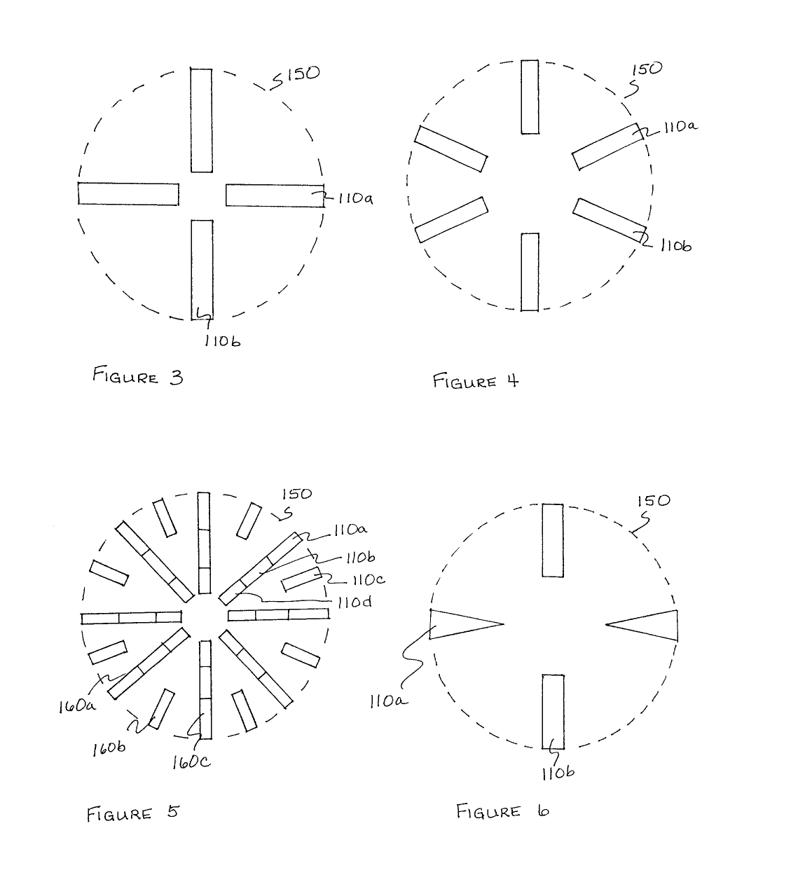

Several aspects of the present invention have been described. However, many modifications to the described embodiment can be made within the scope of the present invention. For example, the PTC elements 110 may have a rectangular, sheet-like shape, as shown in FIG. 1. However, as known to those of skill in the art, any suitable shape may be used. As also shown in FIG. 1, multiple PCT elements 110 can be placed on a single radial flange, e.g., 110a and 110b on 160d. Although the PTC element arrangement in FIG. 1 has sixteen PTC elements 110 arranged with two PTC elements 110 per radial flange 160, many alternative radial PTC element arrangements are possible as shown in FIGS. 3 through 6. More or fewer than two PTC elements 110 can be placed per flange 160, and the number of flanges 160 can likewise vary. Because each PTC element 110 may have a power limit, positioning multiple PTC elements 110 on a single radial flange 160 may allow the heating element 100 to produce more heat per flange without damaging the PTC elements 110. Additionally, the number, sizes, and shapes of PTC elements 110 included in each flange 160 do not have to be uniform between radial flanges 160, as shown in FIGS. 5 and 6. Thus, the arrangement of PTC elements 110 can be sized and configured to provide the desired power output while maintaining a desired heat distribution within the heating element 100. That is, the heater 100 may be configured to have an uneven internal heat distribution, although in many cases an even internal heat distribution may be desirable.

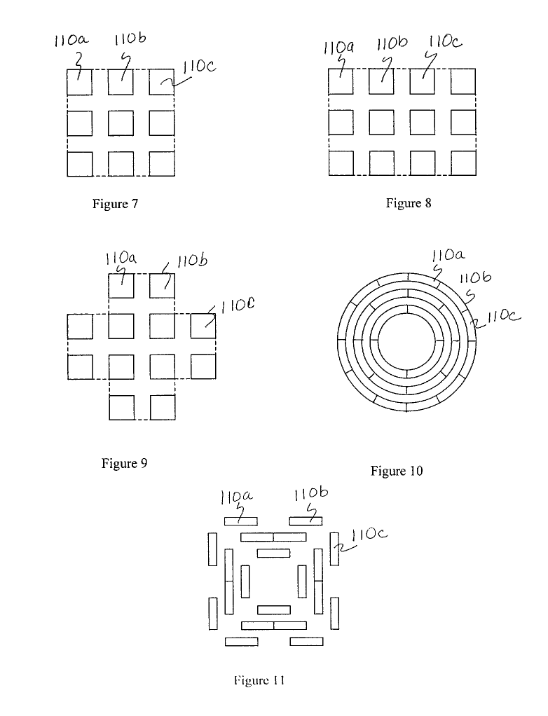

In another embodiment of the present invention, the PTC elements 110 can be placed in a grid-like pattern. As shown in FIGS. 7-9, the perimeter of this grid-like pattern can be square, rectangular, or any other shape with any number and shape of PTC elements 110 aligned in the grid. Again, the PTC element grid can be sized and configured to optimize the heating element 100 for its desired use.

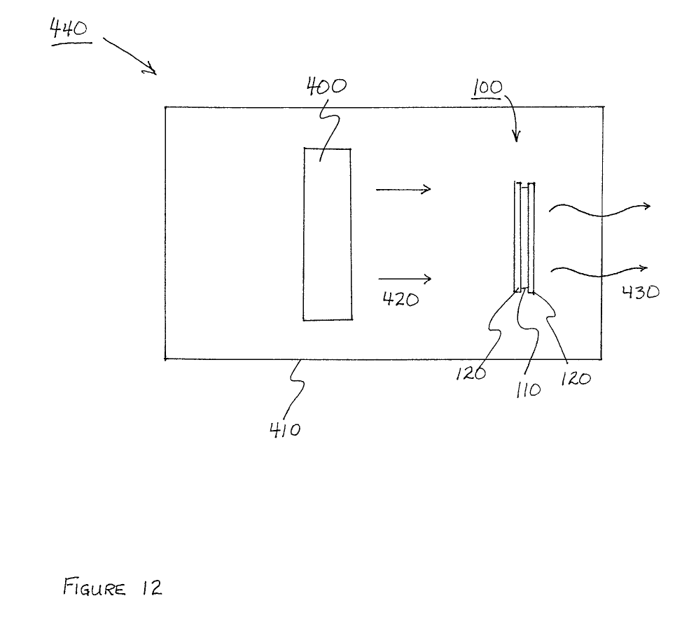

Many other PTC element configurations are possible. Two alternative configurations are shown in FIGS. 10 and 11. Notably, for all of the PTC element configurations of FIGS. 3 through 11, the PTC elements 110 are arranged such that the broad opposing surfaces 180 of the PTC elements are aligned in one or more planes. As noted above, to increase the conductive surface area with the heat sinks 120, the broad opposing surfaces 180 also may be the sides with the largest surface area.

Although in FIG. 1 the openings 140 in the heat sinks 120 have an arcuate shape, the openings 140 can have any suitable configuration, size and/or shape. Specifically, the openings 140 can be rectangular slots that are radially oriented, rectangular slots that are arranged like chords, triangular holes, circular holes, or any other configuration of shapes and sizes. The shape of the heat sink 120 and placement of the solid portions and openings 140 of the heat sink can be altered to accommodate different PTC element configurations. For example, the heat sinks 120 can be configured such that their solid portions substantially shield the PTC elements 110 from direct airflow regardless of the PTC element configuration chosen.

Although the fasteners 130 are located at the ends of the radial flanges 160 in FIG. 1, the fasteners 130 may be placed in many different locations in the heating element 100. For example, the fasteners 130 alternatively or additionally can be placed along the sides of the radial flanges 160 or between the radial flanges 160. The fasteners 130 may also be configured to hold a clamping mechanism or brace instead of contacting the heat sinks 120 directly. If it includes an electrically insulating material, a clamping mechanism or brace could additionally be used to prevent short circuiting when the heat sinks 120 are used as electrodes.

The fasteners 130 may be any of various types as well. Rivets are depicted in FIG. 1, but as known to those of skill in the art, many types of fasteners such as screws, bolts, press fit fittings, and clamps can also be used. Additionally, welds, epoxy, or other adhesives can be used to fasten the heat sinks 120 together and hold the PTC elements 110 firmly in place with sufficient electrical and thermal contact between the heat sinks 120 and the PTC elements 110. If an adhesive such as epoxy is used, fasteners 130 may be unnecessary.

As shown in FIG. 12, a heating element 100 can be used in a portable heater 440 which is sized and configured to allow a single human to carry it without mechanical assistance. In a portable air heater 440, at least one heating element 100 may be placed in front of air movement means such as a fan 400 inside a housing 410. The fan 400 may direct air substantially perpendicular to the heating element 100 as shown by the arrows 420. As the air passes by and/or through the heating element 100, at least a portion of it is heated by the heat sinks 120 and/or the PTC elements 110. At least part of the heated air is then vented out of the housing 410 as shown by the arrows 430.

Although aspects of the present invention have been fully described by way of example, modifications to the designs can be made within the scope of the invention as known to those of skill in the art. Therefore, the examples used herein should not be construed as limiting, but merely intended to completely describe an illustrative embodiment of the invention.

What is claimed is:

1. A heating element, comprising:
a first heat sink having at least one opening, wherein a fluid pathway is formed through said first heat sink; and
at least one PTC element thermally coupled to the first heat sink and having a current direction, wherein the at least one PTC element is substantially aligned such that said current direction is substantially parallel to said fluid pathway.

2. The heating element of claim 1, wherein said first heat sink includes thermally conductive material and is positioned such that said at least one PTC element transmits heat to said first heat sink.

3. The heating element of claim 2, wherein said thermally conductive material comprises at least one of copper, stainless steel, and steel.

4. The heating element of claim 1, wherein said at least one PTC element is substantially shielded from said fluid pathway.

5. The heating element of claim 4, wherein said at least one PTC element has a surface area and said fluid pathway is adjacent to less than 50% of the surface area of said at least one PTC element.

6. The heating element of claim 4, wherein said first heat sink includes solid portions, and said solid portions of said first heat sink are aligned over said at least one PTC element such that said solid portions of said first heat sink substantially shield said at least one PTC element from being in the fluid pathway.

7. The heating element of claim 1, comprising a plurality of PTC elements radially arranged within a circle.

8. The heating element of claim 7, wherein said radial arrangement comprises a plurality of radial flanges, and at least one radial flange includes a plurality of PTC elements.

9. The heating element of claim 1, further comprising a second heat sink attached to said first heat sink, wherein said first and second heat sinks include electrically conductive material, and said at least one PTC element electrically contacts both said first and second heat sinks.

10. The heating element of claim 9, wherein said first and second heat sinks are configured to carry an electric supply to and from said at least one PTC element.

11. The heating element of claim 10, further comprising fasteners which attach said first heat sink to said second heat sink and electrically isolate said first heat sink from said second heat sink, wherein said fasteners are located and configured to generate pressure between said first and second heat sinks and said at least one PTC element.

12. The heating element of claim 10, comprising a plurality of PTC elements, each having a surface area, arranged radially within a circle, such that said fluid pathway is adjacent to less than 50% of said surface area of said plurality of PTC elements.

13. The heating element of claim 12, wherein said plurality of PTC elements are rectangular in shape.

14. The heating element of claim 13, wherein said first and second heat sinks include openings for permitting fluid flow and wherein said plurality of PTC elements are positioned at least partially away from said openings.

15. The heating element of claim 12, wherein said heating element is configured such that at least one of said heat sinks substantially shields said plurality of PTC elements from said fluid pathway.

16. The heating element of claim 12, wherein said radial arrangement comprises radial flanges, and said plurality of PTC elements is arranged such that there is more than one PTC element in at least one radial flange.

17. The heating element of claim 10, further comprising conductive grease between said plurality of PTC elements and said first and second heat sinks.

18. The heating element of claim 1, further comprising a second heat sink attached to said first heat sink and thermally coupled to said at least one PTC element, wherein said at least one PTC element transfers at least 80% of its heat output to said heat sinks.

19. The heating element of claim 1, wherein said at least one PTC element is rectangular in shape.

20. The heating element of claim 1, comprising a plurality of PTC elements arranged such that broad surfaces of the plurality of PTC elements are aligned in a plane substantially perpendicular to said fluid pathway.

21. The heating element of claim 1, wherein said heating element is sized to fit a portable space heater.

22. A heater, comprising:
a housing;
the heating element of claim 1; and
an air circulator which generates an fluid flow that is directed substantially through said fluid pathway.

23. The heater of claim 22, wherein said first heat sink includes thermally conductive material such that said at least one PTC element transmits heat to said first heat sink.

24. The heater of claim 22, wherein said at least one PTC element has a surface area, and said first heat sink defines said fluid pathway adjacent to less than 50% of the surface are of said at least one PTC element.

25. The heater of claim 22, comprising a plurality of PTC elements radially arranged within a circle.

26. The heater of claim 22, wherein:
said first heat sink includes electrically conductive material;
said at least one PTC element electrically contacts said first heat sink; and
said first heat sink is configured to carry an electric supply at least one of to and from said at least one PTC element.

27. A heating element comprising:
a first heat sink having at least one opening formed through the heat sink, wherein a fluid pathway is formed through said first heat sink; and
a PTC element thermally coupled to the first heat sink, the PTC element positioned substantially out of said fluid pathway and so that a largest surface area of the PTC element is approximately perpendicular to the fluid pathway.

28. The heating element of claim 27, wherein said first heat sink includes a thermally conductive material, such that said PTC element transfers heat to said first heat sink.

29. The heating element of claim 28, wherein said first heat sink includes at least one of copper, stainless steel, and steel.

30. The heating element of claim 27, comprising a plurality of PTC elements radially arranged within a circle.

31. A heating element comprising:
at least one heat sink having at least one opening formed in the at least one heat sink, wherein a fluid pathway is formed through said at least one opening in the at least one heat sink; and
a PTC element thermally coupled to the at least one heat sink such that at least 50% of the heat output by said PTC element is transferred to heat sinks coupled to the PTC element, and arranged so that a largest surface of the PTC element is approximately perpendicular to said fluid pathway.

32. The heating element of claim 31, wherein said PTC element transfers at least 80% of its heat output to said first heat sink.

33. The heating element of claim 31, comprising a plurality of PTC elements arranged radially within a circle.

34. A heating element, comprising:
a first heat sink having at least one opening;
a second heat sink attached to said first heat sink and having at least one opening, wherein a fluid pathway is formed through said first and second heat sinks by way of said openings; and
a plurality of PTC elements each having a current direction and radially arranged inside a circle, wherein the plurality of elements is substantially aligned in a single plane between the first and second heat sinks such that said current direction in said plurality of PTC elements is substantially parallel;
wherein said first and second heat sinks are configured to act as electrodes for said plurality of PTC elements.

35. A heating element, comprising:
a heat sink having at least one opening wherein a fluid pathway is formed through said heat sink; and
at least one PTC element in thermal communication with said heat sink, the heat sink and at least one of the PTC elements arranged such that said fluid pathway first passes one of said heat sink and said at least one PTC element and then passes the other of said heat sink and said at least one PTC element.
